(19) United States
(12) Patent Application Publication
(10) Pub. No.: US 2026/0208571 A1
(43) Pub. Date: Jul. 23, 2026

(54) WEATHERSTRIP

(71) Applicant: TOYODA GOSEI CO., LTD., Kiyosu-shi (JP)

(72) Inventor: Tsubasa Shinoda, Kiyosu-shi (JP)

(21) Appl. No.: 19/401,527

(22) Filed: Nov. 26, 2025

(30) Foreign Application Priority Data
Jan. 17, 2025 (JP) 2025-006778

(51) Int. Cl. B60J 10/77; B60J 10/16; B60J 10/24; B60J 10/27

(52) U.S. Cl. CPC B60J 10/77; B60J 10/16; B60J 10/24; B60J 10/27

(57) ABSTRACT

A weatherstrip is attached to a vehicle body opening portion periphery of a vehicle body of an automobile having a sashless door, and seals between the vehicle body opening portion periphery and a peripheral portion of a door glass, and the weatherstrip includes a mounting base portion attached on the vehicle body opening portion periphery side, and a seal portion that comes into contact with the door glass, in which the seal portion has a hollow shape or a lip shape, the seal portion includes a seal portion hard portion, and the door glass comes into contact with the seal portion hard portion.

### CROSS REFERENCE TO RELATED APPLICATION

This application claims the priority benefit of Japanese Patent Application No. 2025-006778 filed on January 17, 2025. The entirety of the above-mentioned patent application is hereby incorporated by reference herein and made a part of this application.

### BACKGROUND OF THE INVENTION

### (1) Field of the Invention

The present invention relates to a weatherstrip which is attached to a vehicle body opening portion periphery of a vehicle body of an automobile having a sashless door, and which seals between the vehicle body opening portion periphery and a peripheral portion of a door glass.

### (2) Description of Related Art

Improving quietness of vehicles such as automobiles enhances the comfort of occupants and therefore serves as a strong appeal point for improving product value. Further, in electric vehicles, which are becoming increasingly widespread, the conventional engine is no longer installed, and with the elimination of engine noise, the primary remaining noises that become noticeable are road noise and wind noise. Therefore, there is an increasing need for these reduction techniques.

For example, there is known a technique of reducing vibration by using impedance matching that brings the impedance of a glass run close to the impedance of glass by increasing the rigidity of the glass run (for example, Japanese Patent Application Laid-Open No. 2023-53894).

FIG. 8 illustrates a technique disclosed in Japanese Patent Application Laid-Open No. 2023-53894. A glass run 100 includes a bottom wall 200, a vehicle outer side wall 300, and a vehicle inner side wall 400 as its basic structure. The basic structure is attached to a door frame groove portion 500 formed in a door frame 310 and guides the raising and lowering of a door glass 600. On the vehicle inner side of the vehicle outer side wall 300, a thick portion 330 having a hardness higher than that of the vehicle outer side wall main body portion 320 of the vehicle outer side wall 300 is formed to protrude toward the vehicle inner side and come into sliding contact with the door glass 600.

When the thick portion 330 having high hardness comes into contact with the door glass 600, vibration can be reduced by efficiently transmitting the vibration energy of the door glass 600 to the glass run 100 through impedance matching.

Further, by bringing the vehicle outer side wall 300, on which the thick portion 330 having high hardness is formed, into contact with the door frame groove portion 500 to form a structure in which the door glass 600 and the door frame groove portion 500 sandwich the vehicle outer side wall 300 including the thick portion 330, it is also possible to increase the rigidity of the vehicle outer side wall with respect to the door glass 600 and the door frame groove portion 500 and reduce vibration.

### SUMMARY OF THE INVENTION

Incidentally, in an automobile, there is also a sashless door in which a door frame (door sash) is eliminated and only a door glass is freely raised and lowered above a belt line portion of a door, that is, only the door glass has an appearance above the belt line portion of the door on a side surface of the automobile.

The reduction of vibration of the door glass related to a weatherstrip which is attached to the vehicle body opening portion periphery of the vehicle body having the sashless door, and which seals between the vehicle body opening portion periphery and a peripheral portion of the door glass, has not been sufficiently studied at present.

The present invention relates to a weatherstrip which is attached to a vehicle body opening portion periphery of a vehicle body of an automobile having a sashless door, and provides a weatherstrip which exhibits an effect of reducing vibration by utilizing impedance matching with a door glass.

In order to solve the above problems, a first aspect of the present invention is a weatherstrip which is attached to a vehicle body opening portion periphery of a vehicle body of an automobile having a sashless door, and which seals between the vehicle body opening portion periphery and a peripheral portion of a door glass, the weatherstrip including a mounting base portion attached on the vehicle body opening portion periphery side, and a seal portion that comes into contact with the door glass, in which the seal portion has a hollow shape or a lip shape, the seal portion includes a seal portion hard portion, and the door glass comes into contact with the seal portion hard portion.

In the first aspect of the present invention, since the weatherstrip includes the mounting base portion attached to the vehicle body opening portion periphery side and the seal portion that comes into contact with the door glass, the seal portion has the hollow shape or the lip shape, the seal portion includes the seal portion hard portion, and the door glass comes into contact with the seal portion hard portion, the seal portion deforms to seal between a vehicle body opening portion periphery and the door glass, increases the rigidity on the weatherstrip side by the seal portion hard portion, and by the seal portion hard portion coming into contact with the door glass, it is possible to efficiently propagate vibration energy of the door glass to the seal portion hard portion by utilizing impedance matching with the door glass.

As a result, even in an automobile having a sashless door, it is possible to reduce vibration of the door glass by the weatherstrip.

Here, the seal portion hard portion is a portion formed of a material having higher hardness than the material constituting the seal portion excluding the seal portion hard portion.

Further, the “rigidity on the weatherstrip side” is represented by an amount of increase in reaction force from a trim portion with respect to an amount of change in a pressed portion when a portion of the weatherstrip that comes into contact with the door glass is pressed. Therefore, in the seal portion, by forming the seal portion hard portion, in a relationship between displacement and reaction force, its slope (gradient) becomes large.

A second aspect of the present invention is the weatherstrip according to the first aspect, in which the seal portion has a hollow shape, the mounting base portion includes a mounting base hard portion and a mounting base lip that is connected to the mounting base hard portion and projects toward an inner side direction of the hollow portion, the mounting base lip includes a mounting base lip hard portion connected to the mounting base hard portion, and the seal portion hard portion comes into contact with the mounting base lip hard portion.

In the second aspect of the present invention, since the seal portion has the hollow shape, the mounting base portion includes the mounting base hard portion and the mounting base lip that is connected to the mounting base hard portion and projects toward the inner side direction of the hollow portion, the mounting base lip includes the mounting base lip hard portion connected to the mounting base hard portion, and the seal portion hard portion comes into contact with the mounting base lip hard portion, it is possible to efficiently dissipate vibration energy of the door glass, which has been propagated to the seal portion hard portion by utilizing impedance matching with the door glass, to the mounting base hard portion through the mounting base lip hard portion. As a result, in an automobile having a sashless door, it is possible to further reduce vibration of the door glass by the weatherstrip.

Here, the mounting base hard portion refers to a portion that is formed of a material having a higher hardness than a material constituting the mounting base portion excluding the mounting base hard portion, and the mounting base lip hard portion refers to a portion that is formed of a material having a higher hardness than a material constituting the mounting base lip excluding the mounting base lip hard portion.

From the viewpoint of vibration energy propagation by impedance matching, it is desirable that the hardness of the seal portion hard portion, the mounting base lip hard portion, and the mounting base hard portion be the same or close to each other.

Further, by bringing the mounting base hard portion into contact with a flange or retainer located on the vehicle body opening portion periphery side to which the mounting base portion is attached, the vibration energy of the door glass can be further dissipated from the mounting base hard portion toward the vehicle body opening portion periphery side.

A third aspect of the present invention is the weatherstrip according to the first aspect, in which the seal portion has a hollow shape, a vehicle outer side wall is provided between the mounting base portion and the seal portion, the vehicle outer side wall includes a vehicle outer side wall hard portion exposed to a vehicle inner side, and the seal portion hard portion comes into contact with the vehicle outer side wall hard portion.

In the third aspect of the present invention, since the seal portion has the hollow shape, the vehicle outer side wall is provided between the mounting base portion and the seal portion, the vehicle outer side wall includes the vehicle outer side wall hard portion that is exposed on the vehicle inner side, and the seal portion hard portion comes into contact with the vehicle outer side wall hard portion, it is possible to dissipate vibration energy of the door glass transmitted to the seal portion hard portion to the vehicle outer side wall via the vehicle outer side wall hard portion by utilizing impedance matching with the door glass. As a result, in an automobile having a sashless door, it is possible to further reduce vibration of the door glass by the weatherstrip.

Here, the vehicle outer side wall hard portion refers to a portion formed of a material having a higher hardness than the material constituting the vehicle outer side wall excluding the vehicle outer side wall hard portion.

A fourth aspect of the present invention is the weatherstrip according to the third aspect, in which the vehicle outer side wall hard portion is formed to penetrate to the vehicle outer side.

In the fourth aspect of the present invention, since the vehicle outer side wall hard portion is formed to penetrate to the vehicle outer side, the vehicle outer side wall hard portion can be brought into contact with a flange or retainer located on the vehicle body opening portion periphery side to which the mounting base portion is attached, and the vibration energy of the door glass can be further dissipated from the vehicle outer side wall hard portion toward the vehicle body opening portion periphery side. As a result, in an automobile having a sashless door, it is possible to further reduce vibration of the door glass by the weatherstrip.

A fifth aspect of the present invention is the weatherstrip according to the first aspect, in which the mounting base portion includes a mounting base hard portion, the seal portion has a lip shape, the seal portion hard portion is formed from a contact region with the door glass to a tip end portion of the seal portion, and the seal portion hard portion comes into contact with the mounting base hard portion.

In the fifth aspect of the present invention, since the mounting base portion includes the mounting base hard portion, the seal portion has the lip shape, the seal portion hard portion is formed from the contact region to the tip end portion of the seal portion, and the seal portion hard portion comes into contact with the mounting base hard portion, vibration energy of the door glass transmitted to the seal portion hard portion can be dissipated to the mounting base hard portion. As a result, in an automobile having a sashless door, it is possible to further reduce vibration of the door glass by the weatherstrip.

A sixth aspect of the present invention is a weatherstrip which is attached to a vehicle body opening portion periphery of a vehicle body of an automobile having a sashless door, and which seals between the vehicle body opening portion periphery and a peripheral portion of a door glass, the weatherstrip including a mounting base portion attached to a vehicle body opening portion periphery side, a seal portion that comes into contact with the door glass, a vehicle inner side wall, and a lip hard portion connected to at least one of the mounting base portion and the vehicle inner side wall, in which the seal portion has a hollow shape including a seal portion bent portion, and the seal portion bent portion comes into contact with the door glass and the lip hard portion.

In the sixth aspect of the present invention, since the weatherstrip includes the seal portion having the hollow shape and provided with the seal portion bent portion, a part of the seal portion becomes a lump-like shape by the seal portion bent portion, thereby increasing rigidity. Then, when the seal portion bent portion having increased rigidity comes into contact with the door glass, impedance matching can be utilized to efficiently transmit the vibration energy of the door glass to the seal portion bent portion. Further, since the seal portion bent portion comes into contact with the lip hard portion connected to at least one of the mounting base portion and the vehicle inner side wall, vibration energy transmitted to the seal portion bent portion can be dissipated to the mounting base portion or the vehicle inner side wall via the lip hard portion. As a result, in an automobile having a sashless door, it is possible to reduce vibration of the door glass by the weatherstrip.

Here, the lip hard portion is formed of a material having a higher hardness than the material constituting the seal portion.

A seventh aspect of the present invention is the weatherstrip according to the sixth aspect, in which at least one of the mounting base portion and the vehicle inner side wall includes a base side hard portion connected to the lip hard portion.

In the seventh aspect of the present invention, since at least one of the mounting base portion and the vehicle inner side wall includes the base side hard portion connected to the lip hard portion, vibration energy transmitted to the lip hard portion can be efficiently dissipated to the mounting base portion side or the vehicle inner side wall side via the base side hard portion. As a result, in an automobile having a sashless door, it is possible to further reduce vibration of the door glass by the weatherstrip.

Note that, by bringing the base side hard portion into contact with the vehicle body opening portion periphery side, vibration energy transmitted to the lip hard portion can be more efficiently dissipated to the vehicle body opening portion periphery side via the base side hard portion.

Here, the base side hard portion refers to a portion formed of a material having a higher hardness than the material constituting the mounting base portion and the vehicle inner side wall.

### BRIEF DESCRIPTION OF THE DRAWINGS

FIG. 1 is a side view of a left side of an automobile;

FIG. 2 is a cross-sectional view taken along line A-A of FIG. 1 according to a first embodiment of the present invention;

FIG. 3 is a cross-sectional view taken along line A-A of FIG. 1 according to a second embodiment of the present invention; However, it is a cross-sectional view when the weatherstrip is assembled to a jig whose inner surface shape is made substantially the same as that of the vehicle body opening portion periphery side, and the door glass is in a fully closed state; and

FIG. 4 is a cross-sectional view taken along line B-B of FIG. 1 according to a third embodiment of the present invention;

FIG. 5 is a cross-sectional view taken along line B-B of FIG. 1 according to a fourth embodiment of the present invention;

FIG. 6 is a cross-sectional view taken along line B-B of FIG. 1 according to a fifth embodiment of the present invention;

FIG. 7 is a cross-sectional view taken along line A-A

of FIG. 1 according to a sixth embodiment of the present invention; However, it is a cross-sectional view when the weatherstrip is assembled to a jig whose inner surface shape is made substantially the same as that of the vehicle body opening portion periphery side, and the door glass is in a fully closed state; and

FIG. 8 is a cross-sectional view illustrating an attachment structure of a conventional glass run (Japanese Patent Application Laid-Open No. 2023-53894).

### DETAILED DESCRIPTION OF PREFERRED EMBODIMENTS

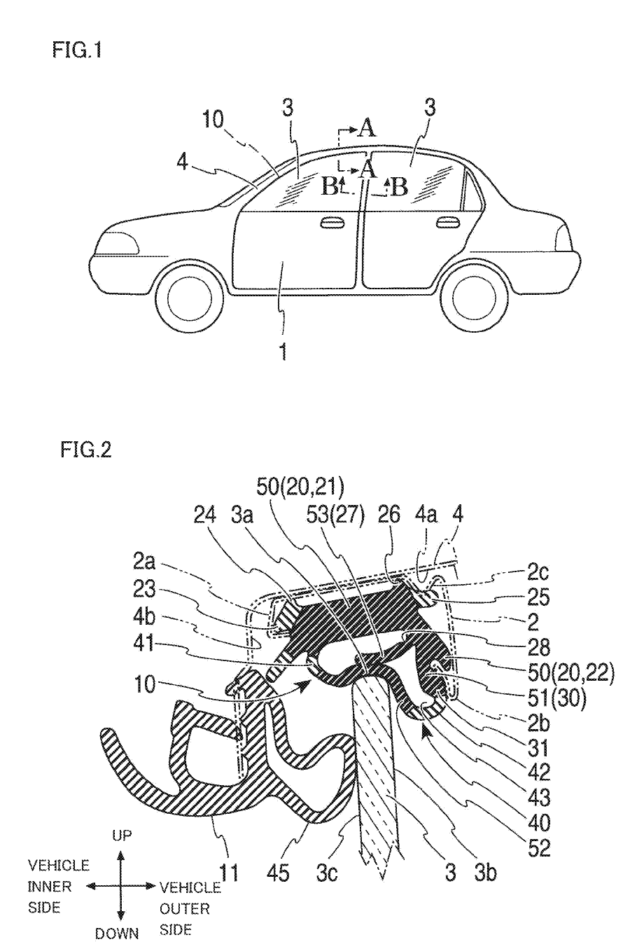

A first embodiment of the present invention will be described with reference to FIGS. 1 and 2. FIG. 1 is a side view of a left side of an automobile. A weatherstrip 10 of the present invention is used for an automobile having a sashless door, and on both the front door and the rear door, which are doors 1 located on the side of the automobile, there is no door sash (door frame) above the beltline portion, a door glass 3 is provided over substantially the entire area, and the door glass 3 can move up and down from the door 1. It should be noted that the present invention is applicable not only to the left front door, but also to a right front door and both right and left rear doors.

Further, FIG. 1 is also used in the description of second to fifth embodiments described later.

FIG. 2 is a cross-sectional view taken along line A-A of FIG. 1 according to the first embodiment of the present invention. FIG. 2 is a roof side of a vehicle body opening portion periphery 4 (FIG. 1), and corresponds to the upper side portion of the door glass 3 in the weatherstrip 10. Further, FIG. 2 illustrates a state in which the door glass 3 is closed.

On the roof side of the vehicle body, near the vehicle body opening portion periphery 4, the roof is bent continuously toward the vehicle inner side to form an outer panel on the roof side. This outer panel forms a flat portion 4a at an entrance portion of the vehicle body opening portion periphery 4, in which upper ends of the door glasses 3 of the front door and the rear door are housed. A retainer 2 is assembled to the lower surface of the flat portion 4a. The retainer 2 is made of a steel material that has been subjected to bending processing.

The vertical portion 4b bent downward is provided on the vehicle inner side of the flat portion 4a, and the vertical portion 4b is formed such that, from an intermediate portion thereof, its tip end direction is displaced toward the vehicle inner side, and a second weatherstrip 11 is attached to a tip end portion thereof. Although a detailed description of the second weatherstrip 11 is omitted, it includes a second seal portion 45, and the second seal portion 45 comes into contact with a door glass inner surface 3c of the door glass 3.

The retainer 2 has a substantially L-shaped cross section, and at both end portions, that is, at a vehicle inner side end portion and at a vehicle outer side and lower end portion, includes, at the vehicle inner side end portion, a vehicle inner side groove portion 2a having a U-shaped form for housing both end portions of the mounting base portion 20 of the weatherstrip 10, and, at the vehicle outer side and lower end portion, includes a vehicle outer side groove portion 2b having a U-shaped form in which a vehicle inner side tip end portion projects toward the vehicle inner side and upward.

Further, at a corner portion, an engaging portion 2c is provided in which a V-shaped groove shape in the vehicle vertical direction is connected to a mountain shape protruding upward in the vehicle width direction.

The weatherstrip 10 includes the mounting base portion 20, the vehicle outer side wall 30, and a seal portion 40. The vehicle outer side wall 30 is connected to the mounting base portion 20.

The seal portion 40 has a vehicle inner side end portion 41 connected to the mounting base portion 20, a vehicle outer side end portion 42 connected to the vehicle outer side wall 30, and a hollow portion 43 that bulges downward is formed.

The mounting base portion 20 includes a flat side portion 21 facing the flat portion 4a of the vehicle body opening portion periphery 4, and a vehicle outer side portion 22 connected to the flat side portion 21 and extending linearly toward the vehicle outer side and downward.

Further, a vehicle inner side protruding portion 23 protruding toward the vehicle inner side and a vehicle inner side upper protruding portion 24 protruding upward are provided at an upper tip end portion on the vehicle inner side of the flat side portion 21.

Further, a vehicle outer side protruding portion 25 protruding toward the vehicle outer side and a vehicle outer side upper protruding portion 26 protruding upward are provided at a vehicle outer side tip end portion of the flat side portion 21.

The vehicle outer side wall 30 is connected to the vehicle outer side portion 22 of the mounting base portion 20 and extends downward. Further, in the vicinity of a lower tip end portion, a bulging portion 31 that bulges linearly toward the vehicle outer side and downward is provided. The vehicle outer side end portion 42 of the seal portion 40 is connected to a tip end portion of the bulging portion 31.

In the vicinity of a connecting portion between the vehicle outer side portion 22 of the mounting base portion 20 and the vehicle outer side wall 30, a mounting base lip 27 extending toward the vehicle inner side and downward is provided. The mounting base lip 27 is curved convexly downward. Further, a thin lip portion 28 is provided on an upper side of a base portion of the mounting base lip 27.

A region of the mounting base portion 20 including the vehicle inner side protruding portion 23 and the vehicle inner side upper protruding portion 24 and excluding the vehicle outer side protruding portion 25, and regions of the seal portion 40 excluding vicinities of the vehicle inner side end portion 41 and the vehicle outer side end portion 42, are composed of a mounting base hard portion 50, a vehicle outer side wall hard portion 51, a seal portion hard portion 52, and a mounting base lip hard portion 53, which have higher hardness than the above-mentioned portions and regions. Therefore, in the present embodiment, the entire regions of the vehicle outer side wall 30 and the mounting base lip 27 are composed of hard portions.

In the present embodiment, the mounting base hard portion 50, the vehicle outer side wall hard portion 51, the seal portion hard portion 52, and the mounting base lip hard portion 53 are formed using polypropylene (PP), and regions excluding the above-mentioned hard portions are formed using an olefin-based thermoplastic elastomer (TPO) having an International Rubber Hardness Degree (IRHD) of 80±5, and are manufactured by extrusion molding. The mounting base hard portion 50, the vehicle outer side wall hard portion 51, the seal portion hard portion 52, and the mounting base lip hard portion 53 may also be formed using the same TPO as the other portions, in which case the IRHD is preferably 100±5. Further, a hard resin material other than PP, for example, an olefin-based resin such as polystyrene, may be used.

When the weatherstrip 10 is assembled to the retainer 2, the vehicle inner side protruding portion 23 and the vehicle inner side upper protruding portion 24 of the mounting base portion 20 are housed in the vehicle inner side groove portion 2a, and the vehicle outer side portion 22 is housed in the vehicle outer side groove portion 2b. Further, the vehicle outer side protruding portion 25 and the vehicle outer side upper protruding portion 26 engage with the engaging portion 2c.

Further, the vehicle outer side of the bulging portion 31 of the vehicle outer side wall 30 comes into contact with the vehicle inner side of the vehicle outer side groove portion 2b of the retainer 2.

When the weatherstrip 10 is attached to the retainer 2, the hollow portion 43 of the seal portion 40 is in a downwardly bulged shape, and the seal portion 40 and the mounting base lip 27 (mounting base lip hard portion 53) are not in contact with each other.

When the door glass 3 moves upward, a door glass upper tip end portion 3a of the door glass 3 comes into contact with the seal portion hard portion 52, and the seal portion hard portion 52 is deformed so that a recess portion is formed between the seal portion hard portion and the door glass 3, and moves upward so that the degree of deformation increases.

Next, the seal portion hard portion 52 and the mounting base lip hard portion 53 come into contact, and while the contact between the seal portion hard portion 52 and the mounting base lip hard portion 53 is maintained, the mounting base lip hard portion 53 moves upward with a thin lip portion 28 as a base point, and the door glass 3 is finally closed.

As illustrated in FIG. 2, the seal portion hard portion 52 is formed to cover a wide range of the seal portion 40 excluding vicinities of the vehicle inner side end portion 41 and the vehicle outer side end portion 42, that is, a region wider than the thickness of the door glass 3. This is to ensure that the door glass 3 and the seal portion hard portion 52 reliably come into contact even if the contact position with the door glass 3 varies in the vehicle width direction.

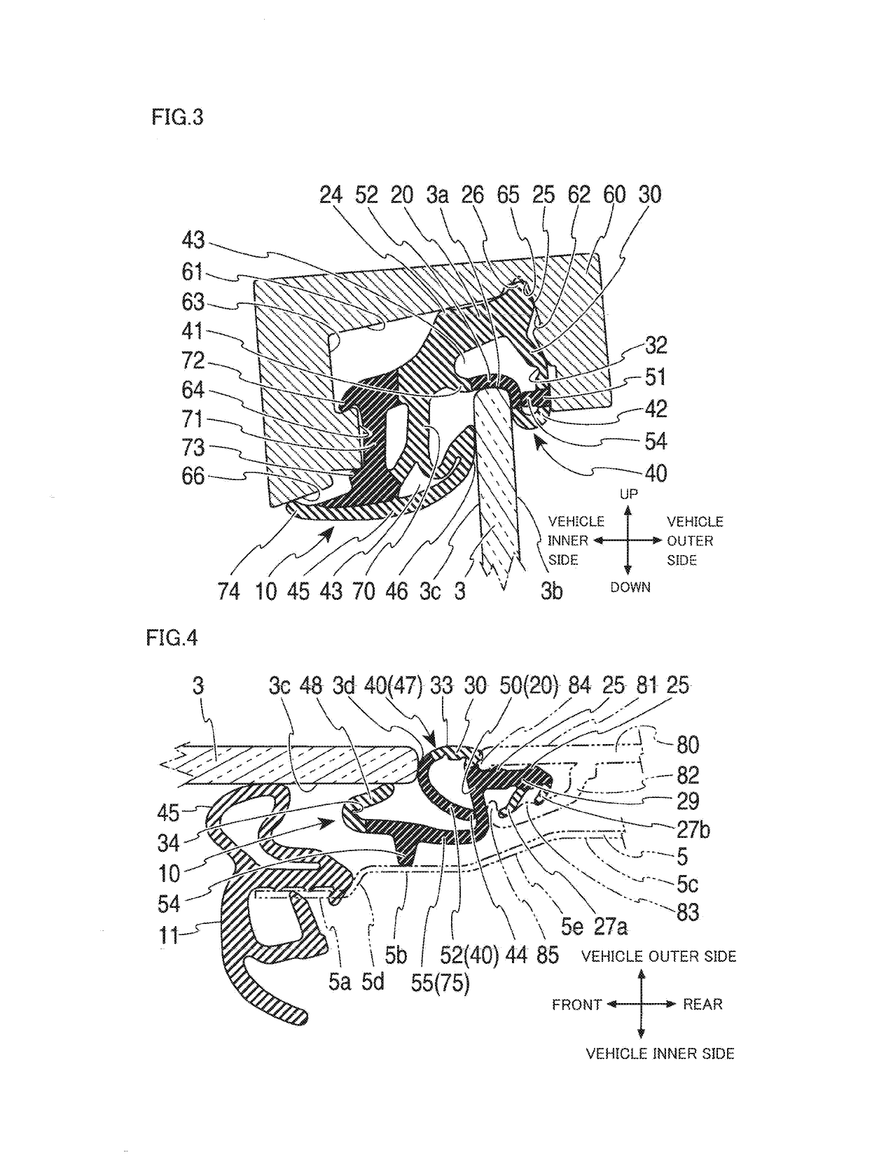

Next, the second embodiment of the present invention will be described with reference to FIG. 3. FIG. 3 is a cross-sectional view taken along line A-A of FIG. 1 according to the second embodiment of the present invention. However, it is a cross-sectional view when the weatherstrip 10 is assembled to a jig 60 whose inner surface shape is made substantially the same as that of the vehicle body opening portion periphery 4 side, and the door glass 3 is in a fully closed state.

The weatherstrip 10 includes the mounting base portion 20, the vehicle outer side wall 30, the seal portion 40, a first vehicle inner side wall 70, a second vehicle inner side wall 71, and the second seal portion 45.

The mounting base portion 20 comes into contact with a jig upper side portion 61 of the jig 60 and a jig vehicle outer side portion 62 of the jig 60. The vehicle inner side upper protruding portion 24 and the vehicle outer side upper protruding portion 26 come into contact with the jig upper side portion 61, and the vehicle outer side protruding portion 25 comes into contact with the jig vehicle outer side portion 62.

The vehicle outer side wall 30 is connected to the mounting base portion 20 and extends downward and toward the vehicle outer side.

Further, in the vicinity of the central portion of the vehicle outer side wall 30, a side wall thin portion 32 is provided on the vehicle inner side to improve the followability to the shape of the jig vehicle outer side portion 62.

Further, the vehicle outer side wall hard portion 51 penetrating from the vehicle inner side to the vehicle outer side is provided below the side wall thin portion 32. Further, a hard portion protruding portion 54 protruding toward the vehicle inner side is provided on the vehicle inner side of the vehicle outer side wall hard portion 51.

The vehicle inner side end portion 41 of the seal portion 40 is connected to the vehicle inner side of the mounting base portion 20, and the vehicle outer side end portion 42 is connected to the vehicle outer side wall hard portion 51, with the hollow portion 43 bulging downward being formed.

Further, excluding the vicinity region of the vehicle inner side end portion 41 and the vicinity region of the vehicle outer side end portion 42, the seal portion hard portion 52 is provided in a region where the door glass upper tip end portion 3a of the door glass 3 comes into contact.

The first vehicle inner side wall 70 is connected to the mounting base portion 20 on the vehicle inner side of a connecting portion between the mounting base portion 20 and the seal portion 40 and is formed extending downward. Further, it is bent toward the vehicle inner side slightly below the central portion.

The second seal portion 45 is connected to the bent portion and a tip end portion of the first vehicle inner side wall 70, is formed toward the vehicle outer side, and has the hollow portion 43 formed therein.

Further, the second seal portion 45 includes a seal portion bent portion 46.

On the vehicle inner side of the first vehicle inner side wall 70, the second vehicle inner side wall 71 is provided, which is connected to upper and lower end portions of the first vehicle inner side wall 70 and includes a hollow portion between the first vehicle inner side wall 70 and the second vehicle inner side wall. Further, on the vehicle inner side of the second vehicle inner side wall 71, a vehicle inner side holding lip 72 and a vehicle inner side holding rib 73 are provided.

Below the vehicle inner side holding rib 73 of the second vehicle inner side wall 71, the wall expands while being inclined toward the vehicle inner side, and at a lower end portion of the second vehicle inner side wall 71, a vehicle inner side cover lip 74 connected to the second seal portion 45 is provided.

The connecting portion between the second vehicle inner side wall 71 and the second seal portion 45 of the first vehicle inner side wall 70 is formed of a material harder than that of the first vehicle inner side wall 70. This is to enhance fixation to the jig 60 and to prevent detachment from the jig 60 after assembly.

When the weatherstrip 10 is assembled to the jig 60, the vehicle outer side upper protruding portion 26 comes into contact with a jig upper recess portion 65 within the jig upper side portion 61, and the vehicle inner side upper protruding portion 24 comes into contact with the jig upper side portion 61.

At the jig vehicle outer side portion 62, the vehicle outer side wall 30 bends at the side wall thin portion 32 to follow the shape of the vehicle inner side surface of the jig vehicle outer side portion 62. Further, the vehicle outer side wall hard portion 51 comes into contact with the vehicle inner side surface of the jig vehicle outer side portion 62.

At a jig vehicle inner side portion 63, the vehicle inner side holding lip 72 and the vehicle inner side holding rib 73 of the second vehicle inner side wall 71 engage with a jig vehicle outer side protruding portion 64, and the vehicle inner side cover lip 74 comes into contact with a jig vehicle inner side lower portion 66.

When the door glass 3 moves upward, a door glass upper tip end portion 3a of the door glass 3 comes into contact with the seal portion hard portion 52, and the seal portion hard portion 52 is deformed so that a recess portion is formed between the seal portion hard portion and the door glass 3, and moves upward so that the degree of deformation increases. Further, as the depth of the recess portion increases, a door glass vehicle outer surface 3b of the door glass 3 also comes into contact with the seal portion hard portion.

Further, the lower side of the seal portion bent portion 46 of the second seal portion 45 comes into contact with the door glass inner surface 3c of the door glass 3, and the seal portion bent portion 46 moves as if being pulled upward.

Finally, the seal portion hard portion 52 and the hard portion protruding portion 54 come into contact with each other, and the door glass 3 is closed.

Next, the third embodiment of the present invention will be described with reference to FIG. 4. FIG. 4 is a cross-sectional view taken along line B-B of FIG. 1 according to the third embodiment of the present invention; FIG. 4 is a pillar side of the vehicle body opening portion periphery 4, and corresponds to the rear longitudinal side portion of the door glass 3 in the weatherstrip 10. Further, FIG. 4 illustrates a state in which the door glass 3 and the weatherstrip 10 are in contact with each other.

The vehicle body opening portion periphery side is provided with a B-pillar 80 and a flange 5. The flange 5 is made of a steel material.

The flange 5 is located on the vehicle inner side of the B-pillar 80, and from the vehicle body front side, a first flat portion 5a, a second flat portion 5b, and a third flat portion 5c are connected by a first stepped portion 5d and a second stepped portion 5e. The second flat portion 5b is positioned more toward the vehicle outer side than the first flat portion 5a, and the third flat portion 5c is positioned more toward the vehicle outer side than the second flat portion 5b.

The second weatherstrip 11 is attached to the first flat portion 5a of the flange 5. Although a detailed description of the second weatherstrip 11 is omitted, it includes a second seal portion 45, and the second seal portion 45 comes into contact with a door glass inner surface 3c of the door glass 3.

The B-pillar 80 includes a B-pillar vehicle outer side portion 81 and a B-pillar vehicle inner side portion 82. The B-pillar vehicle inner side portion 82 is connected to a vehicle inner side surface of the B-pillar vehicle outer side portion 81, and a tip end portion thereof extends to be separated from the B-pillar vehicle inner side portion 82.

Further, on a vehicle outer surface of a substantially central portion of the B-pillar vehicle inner side portion 82, a vehicle inner side stepped portion 83 is provided.

Further, at tip end portions of the B-pillar vehicle outer side portion 81 and the B-pillar vehicle inner side portion 82, a vehicle outer side hook portion 84 and a vehicle inner side hook portion 85 that oppose each other are provided.

The weatherstrip 10 includes the mounting base portion 20, the vehicle outer side wall 30, a vehicle inner side wall 75, a lip-shaped vehicle outer side seal portion 47, and a lip-shaped vehicle inner side seal portion 48.

Further, at a connecting portion between the vehicle outer side wall 30 and the vehicle outer side seal portion 47, a thin-walled vehicle outer side connecting recess portion 33 is provided, and at a connecting portion between the vehicle inner side wall 75 and the vehicle inner side seal portion 48, a thin-walled vehicle inner side connecting recess portion 34 is provided. In the present third embodiment, a vehicle outer side seal portion 47 corresponds to the seal portion 40.

The vehicle outer side seal portion 47 is formed to extend from the vehicle outer side connecting recess portion 33 in a vehicle inner side direction and in a direction away from the mounting base portion 20, being curved convexly, and a tip end portion thereof is further curved convexly and arcuately toward the mounting base portion 20.

On the other hand, the vehicle inner side seal portion 48 is formed to extend from a connecting portion with the vehicle inner side wall 75 toward the vehicle outer side and the mounting base portion 20, being slightly curved convexly and arcuately toward the vehicle inner side wall 75 side.

The mounting base portion 20 includes a mounting base portion protruding portion 29 extending and protruding toward the rear side of the vehicle body. On a vehicle outer surface of the mounting base portion protruding portion 29, two vehicle outer side protruding portions 25 are provided.

Further, on a vehicle inner side surface of the mounting base portion protruding portion 29, two lips, namely a first mounting base lip 27a and a second mounting base lip 27b, are provided.

The regions excluding a connecting portion between the mounting base portion 20 and the vehicle outer side wall 30, the first mounting base lip 27a, the second mounting base lip 27b, the vehicle outer side wall 30, a vicinity of the vehicle outer side connecting recess portion 33 of the vehicle outer side seal portion 47, and a vicinity of the connecting portion between the vehicle inner side seal portion 48 and the vehicle inner side seal portion 48 of the vehicle inner side wall 75 are composed of the mounting base hard portion 50, the seal portion hard portion 52, and the vehicle inner side wall hard portion 55 having higher hardness than the above-mentioned portions.

Further, the vehicle inner side wall hard portion 55 is provided with the hard portion protruding portion 54 that partially projects toward the vehicle inner side.

The weatherstrip 10 is attached to the B-pillar 80 by inserting the mounting base portion protruding portion 29 between the B-pillar vehicle outer side portion 81 and the B-pillar vehicle inner side portion 82 of the B-pillar 80. At this time, the connecting portion between the mounting base portion 20 and the vehicle outer side wall 30 comes into contact with the vehicle outer side hook portion 84, and the mounting base hard portion 50 comes into contact with the vehicle inner side hook portion 85.

Further, the vehicle outer side protruding portion 25 comes into contact with the vehicle inner side surface of the B-pillar vehicle outer side portion 81. Further, on the vehicle outer surface of the B-pillar vehicle inner side portion 82, the second mounting base lip 27b comes into contact with the vehicle body rear side of the vehicle inner side stepped portion 83, and the first mounting base lip 27a comes into contact with the vehicle front side of the vehicle inner side stepped portion 83. As a result, the mounting base portion protruding portion 29 can be prevented from coming off from between the B-pillar vehicle outer side portion 81 and the B-pillar vehicle inner side portion 82 of the B-pillar 80.

Further, the hard portion protruding portion 54 comes into contact with the second flat portion 5b of the flange 5.

In contact between the weatherstrip 10 and the door glass 3, a door glass rear end portion 3d of the door glass 3 comes into contact with the seal portion hard portion 52 of the vehicle outer side seal portion 47, and the seal portion hard portion 52 is pushed rearward in the vehicle body direction, whereby a seal portion tip end portion 44 (seal portion hard portion 52) comes into contact with the mounting base hard portion 50.

On the other hand, a tip end portion of the vehicle inner side seal portion 48 comes into contact with the door glass inner surface 3c of the door glass 3.

Next, the fourth embodiment of the present invention will be described with reference to FIG. 5. FIG. 5 is a cross-sectional view taken along line B-B of FIG. 1 according to the fourth embodiment of the present invention. FIG. 5 is a pillar side of the vehicle body opening portion periphery 4, and corresponds to the rear longitudinal side portion of the door glass 3 in the weatherstrip 10. Further, FIG. 5 illustrates a state in which the door glass 3 and the weatherstrip 10 are in contact with each other. The present fourth embodiment is a modification example of the above third embodiment.

The differences between the present fourth embodiment and the above third embodiment are that, in the present fourth embodiment, firstly, the seal portion hard portion 52 is not formed in the vehicle outer side seal portion 47, secondly, the vehicle outer side seal portion 47 is formed to be short, thirdly, the seal portion hard portion 52 is formed in the vehicle inner side seal portion 48, and the seal portion hard portion 52 is formed in a region excluding the connecting portion between the vehicle inner side wall 75 and the vehicle inner side seal portion 48, that is, in a region on the vehicle outer side of the vehicle inner side connecting recess portion 34, and fourthly, the vehicle inner side seal portion 48 is convex and arcuate in shape, being extended from the connecting portion with the vehicle inner side wall 75 toward the vehicle outer side and the mounting base portion 20, and then curved toward the vehicle inner side wall 75 side. Therefore, in the present fourth embodiment, the vehicle inner side seal portion 48 corresponds to the seal portion 40.

In contact between the weatherstrip 10 and the door glass 3, the door glass rear end portion 3d of the door glass 3 comes into contact with the vehicle outer side seal portion 47 and pushes the vehicle outer side seal portion 47 rearward in the vehicle body direction. At this time, the vehicle outer side seal portion 47 does not come into contact with the mounting base hard portion 50.

On the other hand, on the vehicle inner side, the seal portion hard portion 52 comes into contact with the door glass inner surface 3c of the door glass 3, and the seal portion tip end portion 44 (seal portion hard portion 52) comes into contact with the vehicle inner side wall hard portion 55.

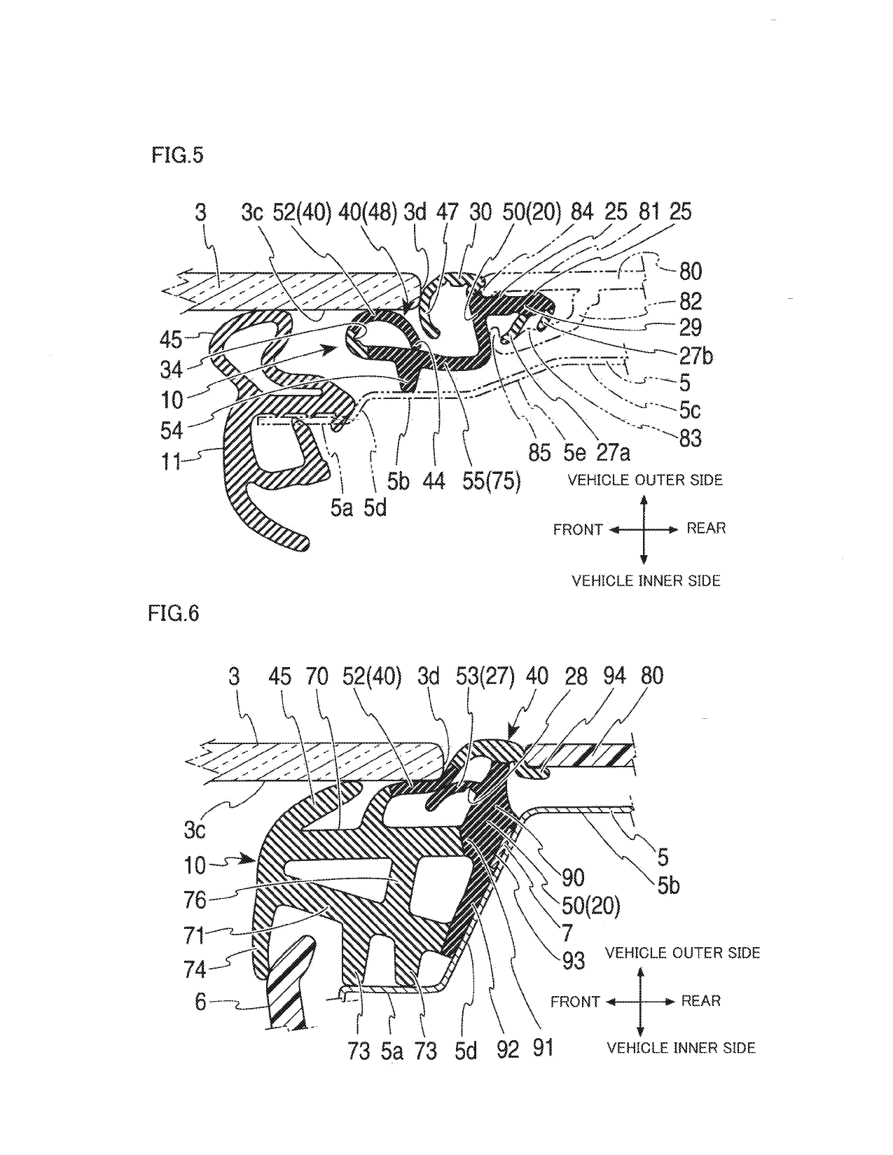

Next, the fifth embodiment of the present invention will be described with reference to FIG. 6. FIG. 6 is a cross-sectional view taken along line B-B of FIG. 1 according to the fifth embodiment of the present invention. FIG. 6 is a pillar side of the vehicle body opening portion periphery 4, and corresponds to the rear longitudinal side portion of the door glass 3 in the weatherstrip 10. Further, FIG. 6 illustrates a state in which the door glass 3 and the weatherstrip 10 are in contact with each other.

In the present fifth embodiment, the weatherstrip 10 is attached to the flange 5. The vehicle body opening portion periphery side is provided with a B-pillar 80 and a flange 5. The flange 5 is located on the vehicle inner side of the B-pillar 80, and from the vehicle body front side, a first flat portion 5a and a second flat portion 5b are connected by a first stepped portion 5d. The second flat portion 5b is positioned more toward the vehicle outer side than the first flat portion 5a.

The weatherstrip 10 includes the mounting base portion 20, the first vehicle inner side wall 70, the second vehicle inner side wall 71, the seal portion 40, the second seal portion 45, and the mounting base lip 27.

The mounting base portion 20 is connected at one end portion to the seal portion 40, at the other end portion to the second vehicle inner side wall 71, and at an intermediate portion to the first vehicle inner side wall 70.

In the mounting base portion 20, between a connecting portion with the first vehicle inner side wall 70 and the connecting portion with the seal portion 40, there are provided a thick portion 90 and a thickness-gradient portion 91 in which the thickness becomes thinner toward the connecting portion with the seal portion 40, and between a connecting portion of the first vehicle inner side wall 70 and the second vehicle inner side wall 71, there is provided a thin portion 92 which is thinner than the thick portion 90 and has a substantially uniform film thickness toward the connecting portion with the second vehicle inner side wall 71. Further, the thick portion 90 is provided with a mounting base recess portion 93. Further, a pillar-side lip 94 is provided on the connecting portion side with the seal portion 40.

The mounting base portion 20 is provided with the mounting base lip 27 extending toward the seal portion 40 side. The mounting base lip 27 is curved convexly toward the seal portion 40 side. Further, on the side of the mounting base portion 20 in the vicinity of the base of the mounting base lip 27, the thin lip portion 28 is provided.

The first vehicle inner side wall 70 and the second vehicle inner side wall 71 are connected to the mounting base portion 20, are connected together at the vehicle body front side, and have a side wall connecting portion 76, having an A-shaped configuration.

Further, on the vehicle inner side of the second vehicle inner side wall 71, two vehicle inner side holding ribs 73 are provided with the side wall connecting portion 76 therebetween.

Further, from a tip end portion of the second vehicle inner side wall 71, the vehicle inner side cover lip 74 is provided toward the vehicle inner side. The vehicle inner side cover lip 74 comes into contact with a vehicle inner side member 6 disposed on the vehicle inner side of the second vehicle inner side wall 71.

The seal portion 40 connects the mounting base portion 20 and the vehicle outer side of the first vehicle inner side wall 70 with the vehicle body front side of the side wall connecting portion 76, and is formed in an arcuate shape bulging in a direction away from the mounting base portion 20 and the first vehicle inner side wall 70.

Further, the second seal portion 45 is formed to extend from a tip end portion of the first vehicle inner side wall 70 toward the vehicle outer side and the mounting base portion 20 side.

The weatherstrip 10 is attached to the first stepped portion 5d of the flange 5 with double-sided tape 7. At this time, the vehicle inner side holding rib 73 comes into contact with the first flat portion 5a of the flange 5.

Further, when the B-pillar 80 is disposed, the pillar-side lip 94 deforms, and a tip end portion and a vehicle inner side of the B-pillar 80 come into contact with the pillar-side lip 94.

The regions excluding the first vehicle inner side wall 70, the second vehicle inner side wall 71, the side wall connecting portion 76, the vehicle inner side holding rib 73, the vehicle inner side cover lip 74, the pillar-side lip 94, the second seal portion 45, a connecting portion between the mounting base portion 20 and the seal portion 40, and a portion of the seal portion 40 that does not come into contact with the door glass 3 are composed of the mounting base hard portion 50, the mounting base lip hard portion 53, and the seal portion hard portion 52 having higher hardness than the above-mentioned portions and regions. Therefore, in the present fifth embodiment, the entire region of the mounting base lip 27 is formed of a hard portion.

In contact between the weatherstrip 10 and the door glass 3, the door glass rear end portion 3d and the door glass inner surface 3c of the door glass 3 come into contact with the seal portion hard portion 52 of the seal portion 40, and the seal portion hard portion 52 deforms so that a recess portion is formed between the seal portion hard portion 52 and the door glass 3, and the seal portion hard portion 52 comes into contact with the mounting base lip hard portion 53.

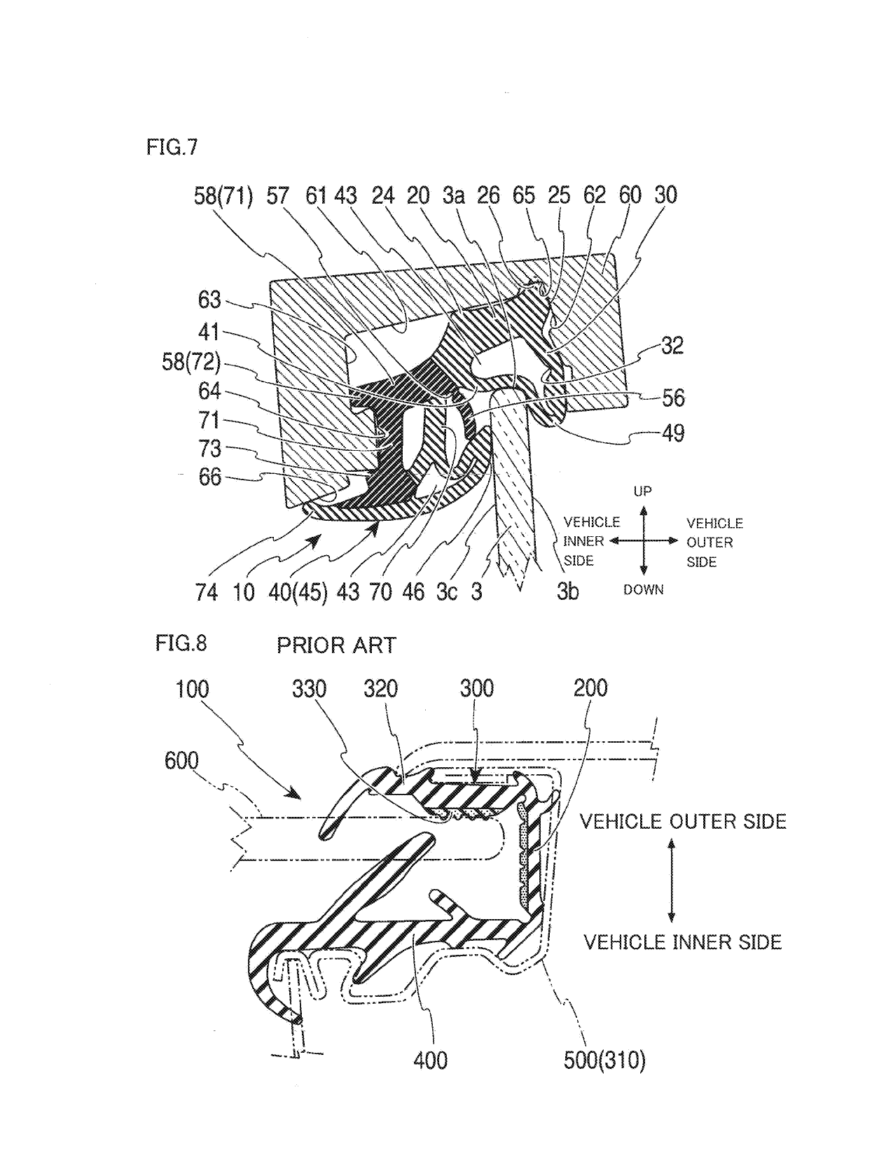

Next, the sixth embodiment of the present invention will be described with reference to FIG. 7. FIG. 7 is a cross-sectional view taken along line A-A of FIG. 1 according to the sixth embodiment of the present invention. However, it is a cross-sectional view when the weatherstrip 10 is assembled to a jig 60 whose inner surface shape is made substantially the same as that of the vehicle body opening portion periphery 4 side, and the door glass 3 is in a fully closed state. The present sixth embodiment is a modification example of the above second embodiment. In the present sixth embodiment, the seal portion 40 corresponds to the second seal portion 45.

The weatherstrip 10 includes the mounting base portion 20, the vehicle outer side wall 30, a first seal portion 49, the first vehicle inner side wall 70, the second vehicle inner side wall 71, and the second seal portion 45 (seal portion 40).

The differences between the present sixth embodiment and the above second embodiment are that, in the present sixth embodiment, first, the vehicle outer side wall 30 is not provided with the vehicle outer side wall hard portion 51 and the hard portion protruding portion 54, and a region where the vehicle outer side wall hard portion 51 was formed in the second embodiment bulges toward the vehicle inner side, second, the first seal portion 49 is not provided with the seal portion hard portion 52, third, an upper end portion of the hard second vehicle inner side wall 71 is extended to a connecting portion between the first vehicle inner side wall 70 and the mounting base portion 20, fourth, the lip hard portion 56, which is connected to the above-described extended hard second vehicle inner side wall 71, is provided below and on the vehicle outer side, and has a convex arcuate shape on the vehicle outer side, and fifth, the vehicle inner side holding lip 72 is formed larger, and when the weatherstrip 10 is assembled to the jig 60, the vehicle inner side holding lip 72 comes into contact with the jig vehicle inner side portion 63.

The above extended hard second vehicle inner side wall 71 connected to the lip hard portion 56 is referred to as a base side hard portion 58. Further, the hardness of the base side hard portion 58 (second vehicle inner side wall 71) is the same as that of the lip hard portion 56.

In the second seal portion 45, the portion of the seal portion bent portion 46 that comes into contact with the lip hard portion 56 has an acute-angled tip end portion and is formed in a thick, solid shape.

Further, on the vehicle inner side of a base portion of the lip hard portion 56, a lip hard portion thin portion 57 is formed.

When the door glass 3 moves upward, the lower side of the seal portion bent portion 46 of the second seal portion 45 comes into contact with the door glass inner surface 3c of the door glass 3, and the seal portion bent portion 46 moves as if being pulled upward.

Further, the door glass upper tip end portion 3a of the door glass 3 comes into contact with the first seal portion 49, and the first seal portion 49 deforms so that a recess portion is formed between itself and the door glass 3, and moves upward so that the degree of deformation becomes larger.

Further, the vehicle inner side of the seal portion bent portion 46 comes into contact with the lip hard portion 56, and the lip hard portion 56 deforms while being in contact with the seal portion bent portion 46 through the lip hard portion thin portion 57.

Finally, in a state where the vehicle inner side of the seal portion bent portion 46 is in contact with the lip hard portion 56, the door glass 3 is closed.

As described in detail above, according to the embodiments of the present invention, the following effects can be obtained.

(1) In the above first embodiment and fifth embodiment, since the weatherstrip 10 includes the mounting base portion 20 attached to the vehicle body opening portion periphery 4 and the seal portion 40 that comes into contact with the door glass 3, the seal portion 40 having a hollow shape, the seal portion 40 includes the seal portion hard portion 52, and the door glass 3 comes into contact with the seal portion hard portion 52, the seal portion 40 bends and deforms to seal between the vehicle body opening portion periphery 4 and the door glass 3, increases the rigidity on the side of the weatherstrip 10 by the seal portion hard portion 52, and enables vibration energy of the door glass 3 to be efficiently propagated to the seal portion hard portion 52 by utilizing impedance matching with the door glass 3. As a result, even in an automobile having a sashless door, it is possible to reduce vibration of the door glass 3 by the weatherstrip 10.

(2) Further, since the mounting base portion 20 includes the mounting base hard portion 50 and the mounting base lip 27 that is connected to the mounting base hard portion 50 and projects toward the inner side of the hollow portion 43, the mounting base lip 27 includes the mounting base lip hard portion 53, and the seal portion hard portion 52 comes into contact with the mounting base lip hard portion 53, it is possible, by utilizing impedance matching with the door glass 3, to dissipate vibration energy of the door glass 3 transmitted to the seal portion hard portion 52 to the mounting base hard portion 50 through the mounting base lip hard portion 53. As a result, even in a vehicle body of a sashless door type, it is possible to further reduce vibration of the door glass 3 by utilizing impedance matching that makes the impedance on the side of the weatherstrip 10 closer to that of the glass.

(3) Further, in the first embodiment, since the mounting base hard portion 50 comes into contact with the retainer 2 and the vehicle outer side upper protruding portion 26, and the vehicle outer side wall hard portion 51 comes into contact with the retainer 2 and the vehicle outer side groove portion 2b, and further, in the fifth embodiment, since the mounting base hard portion 50 comes into contact with the flange 5, vibration energy of the door glass 3 transmitted to the mounting base hard portion 50 can be dissipated to the vehicle body side through the retainer 2 and the flange 5. As a result, even in a vehicle body of a sashless door type, it is possible to further reduce vibration of the door glass 3 by utilizing impedance matching that makes the impedance on the side of the weatherstrip 10 closer to that of the glass.

(4) In the above second embodiment, since the seal portion 40 has a hollow shape, the vehicle outer side wall 30 is provided between the mounting base portion 20 and the seal portion 40, the vehicle outer side wall 30 includes the vehicle outer side wall hard portion 51 penetrating from the vehicle inner side to the vehicle outer side, the vehicle outer side wall hard portion 51 includes the hard portion protruding portion 54 protruding toward the vehicle inner side, and the seal portion hard portion 52 comes into contact with the hard portion protruding portion 54, in addition to the effect (1) described above, vibration energy of the door glass 3 transmitted to the seal portion hard portion 52 can be dissipated to the vehicle outer side wall hard portion 51 through the hard portion protruding portion 54 by utilizing impedance matching with the door glass 3. As a result, even in a vehicle body of a sashless door type, it is possible to further reduce vibration of the door glass 3 by utilizing impedance matching that makes the impedance on the side of the weatherstrip 10 closer to that of the glass.

(5) Further, since the vehicle outer side wall hard portion 51 is formed to penetrate from the vehicle inner side to the vehicle outer side, the vehicle outer side of the vehicle outer side wall hard portion 51 can dissipate to the jig 60 (to the vehicle body side via the retainer 2 of the first embodiment in the case of an automobile). As a result, even in a vehicle body of a sashless door type, it is possible to further reduce vibration of the door glass 3 by utilizing impedance matching that makes the impedance on the side of the weatherstrip 10 closer to that of the glass.

(6) In the above third embodiment and fourth embodiment, the seal portion 40 has a lip shape, and since, in the third embodiment, the seal portion hard portion 52 is formed in the vehicle outer side seal portion 47, and in the fourth embodiment, the seal portion hard portion 52 is formed in the vehicle inner side seal portion 48, and it deforms and comes into contact with the door glass 3, the vibration energy of the door glass 3 can be efficiently propagated to the seal portion hard portion 52 by utilizing impedance matching with the door glass 3. As a result, even in an automobile having a sashless door, it is possible to reduce vibration of the door glass 3 by the weatherstrip 10.

(7) Further, since, in the third embodiment, the seal portion hard portion 52 comes into contact with the mounting base hard portion 50, and in the fourth embodiment, the seal portion hard portion 52 comes into contact with the vehicle inner side wall hard portion 55, the vibration energy of the door glass 3 propagated to the seal portion hard portion 52 can be dissipated to the mounting base hard portion 50 or the vehicle inner side wall hard portion 55. As a result, even in a vehicle body of a sashless door type, it is possible to further reduce vibration of the door glass 3 by utilizing impedance matching that makes the impedance on the side of the weatherstrip 10 closer to that of the glass.

(8) Further, in the third embodiment, since the mounting base hard portion 50 is connected to the vehicle inner side wall hard portion 55, and the hard portion protruding portion 54 is formed on the vehicle inner side wall hard portion 55, and the hard portion protruding portion 54 comes into contact with the flange 5, vibration energy of the door glass 3 transmitted to the mounting base hard portion 50 can be dissipated to the flange 5, that is, to the vehicle body side through the vehicle inner side wall hard portion 55. As a result, even in a vehicle body of a sashless door type, it is possible to further reduce vibration of the door glass 3 by utilizing impedance matching that makes the impedance on the side of the weatherstrip 10 closer to that of the glass.

(9) On the other hand, in the fourth embodiment, since the hard portion protruding portion 54 is formed on the vehicle inner side wall hard portion 55 and comes into contact with the flange 5, vibration energy of the door glass 3 propagated to the vehicle inner side wall hard portion 55 can be dissipated to the flange 5, that is, to the vehicle body side. As a result, even in a vehicle body of a sashless door type, it is possible to further reduce vibration of the door glass 3 by utilizing impedance matching that makes the impedance on the side of the weatherstrip 10 closer to that of the glass.

(10) In the above sixth embodiment, since the second seal portion 45, which is the seal portion 40, has a hollow shape and includes a seal portion bent portion 46, a part of the seal portion 40 becomes a lump-like shape by the seal portion bent portion 46, thereby increasing rigidity. Then, when the seal portion 40 (seal portion bent portion 46) having increased rigidity comes into contact with the door glass 3, impedance matching can be utilized to efficiently transmit the vibration energy of the door glass 3 to the seal portion bent portion 46. Further, since the seal portion bent portion 46 comes into contact with the lip hard portion 56, vibration energy transmitted to the seal portion bent portion 46 can be transmitted to the lip hard portion 56. As a result, in an automobile having a sashless door, it is possible to reduce vibration of the door glass 3 by the weatherstrip 10.

(11) Further, since the lip hard portion 56 is formed to be connected to the base side hard portion 58, vibration energy transmitted to the lip hard portion 56 can be dissipated to the base side hard portion 58.

(12) Further, since the base side hard portion 58 is in contact with the jig vehicle inner side portion 63 of the jig 60, vibration energy transmitted to the lip hard portion 56 can be dissipated more efficiently to the jig 60 side, that is, from the vehicle inner side holding lip 72 to the jig vehicle inner side portion 63 (the vehicle body opening portion periphery 4 side) via the base side hard portion 58.

The embodiment of the present invention is not limited to the above embodiment, and various modifications can be made without departing from the object of the present invention.

For example, in the above first embodiment, although the entire regions of the vehicle outer side wall 30 and the mounting base lip 27 are formed as hard portions, as long as the vibration energy of the door glass 3 can be transmitted from the mounting base hard portion 50 to the vehicle outer side groove portion 2b of the retainer 2 through the vehicle outer side wall 30, the vehicle outer side wall hard portion 51 may be formed in a part of the vehicle outer side wall 30, and as long as the vibration energy of the door glass 3 can be transmitted from the seal portion hard portion 52 to the mounting base hard portion 50 through the mounting base lip 27 that comes into contact with both the seal portion hard portion 52 and the mounting base hard portion 50, the mounting base lip hard portion 53 may be formed in a part of the mounting base lip 27.

For example, in the above fourth embodiment, the mounting base hard portion 50 is formed in the mounting base portion 20; however, the mounting base hard portion 50 does not necessarily have to be formed in the mounting base portion 20.

For example, in the above sixth embodiment, although the entire second vehicle inner side wall 71 is formed as the base side hard portion 58 and its hardness is made the same as that of the lip hard portion 56, a portion connected to the lip hard portion 56 and reaching the jig vehicle inner side portion 63 may be formed, as an energy dissipation route, of a material having the same hardness as the lip hard portion 56, and the portion for assembly to the jig 60 may be formed, from the viewpoint of preventing detachment from the jig 60 after assembly, of a material having a different hardness with an appropriate hardness.

For example, in the above sixth embodiment, the second vehicle inner side wall 71 is the base side hard portion 58; however, the base side hard portion 58 may be formed in the mounting base portion 20.

What is claimed is:

1. A weatherstrip which is attached to a vehicle body opening portion periphery of a vehicle body of an automobile having a sashless door, and which seals between the vehicle body opening portion periphery and a peripheral portion of a door glass, the weatherstrip comprising:
a mounting base portion attached on the vehicle body opening portion periphery side; and
a seal portion that comes into contact with the door glass,
wherein
the seal portion has a hollow shape or a lip shape,
the seal portion includes a seal portion hard portion, and
the door glass comes into contact with the seal portion hard portion.

2. The weatherstrip according to claim 1, wherein
the seal portion has a hollow shape,
the mounting base portion includes a mounting base hard portion and a mounting base lip that is connected to the mounting base hard portion and projects toward an inner side direction of the hollow portion,
the mounting base lip includes a mounting base lip hard portion connected to the mounting base hard portion, and
the seal portion hard portion comes into contact with the mounting base lip hard portion.

3. The weatherstrip according to claim 1, wherein
the seal portion has a hollow shape,
a vehicle outer side wall is provided between the mounting base portion and the seal portion,
the vehicle outer side wall includes a vehicle outer side wall hard portion exposed to a vehicle inner side, and
the seal portion hard portion comes into contact with the vehicle outer side wall hard portion.

4. The weatherstrip according to claim 3, wherein the vehicle outer side wall hard portion is formed to penetrate toward a vehicle outer side.

5. The weatherstrip according to claim 1, wherein
the mounting base portion includes a mounting base hard portion,
the seal portion has a lip shape,
the seal portion hard portion is formed from a contact region with the door glass to a tip end portion of the seal portion, and
the seal portion hard portion comes into contact with the mounting base hard portion.

6. A weatherstrip which is attached to a periphery of a vehicle body opening portion of a vehicle body of an automobile having a sashless door, and which seals between the vehicle body opening portion periphery and a peripheral portion of a door glass, the weatherstrip comprising:
a mounting base portion attached to a vehicle body opening portion periphery side;
a seal portion that comes into contact with the door glass;
a vehicle inner side wall; and
a lip hard portion connected to at least one of the mounting base portion and the vehicle inner side wall, wherein
the seal portion has a hollow shape including a seal portion bent portion, and
the seal portion bent portion comes into contact with the door glass and the lip hard portion.

7. The weatherstrip according to claim 6, wherein at least one of the mounting base portion and the vehicle inner side wall includes a base side hard portion connected to the lip hard portion.
